(19) United States
(12) Patent Application Publication
(10) Pub. No.: US 2016/0182233 A1
(43) Pub. Date: Jun. 23, 2016

(54) POWER INFORMATION TRANSMITTING AND RECEIVING SYSTEM IN SMART GRID

(71) Applicant: KOREA INTERNET & SECURITY AGENCY, Seoul (KR)

(72) Inventors: Woong GO, Yongin-si (KR); Jeong Jun SUH, Seongnam-si (KR); Hae Ryong PARK, Incheon (KR)

(21) Appl. No.: 14/960,708

(22) Filed: Dec. 7, 2015

(30) Foreign Application Priority Data
Dec. 19, 2014 (KR) 10-2014-0184542

(51) Int. Cl. H04L 9/32; G05F 1/66; H04L 12/28

(52) U.S. Cl. CPC H04L 9/3242; H04L 12/2816; G05F 1/66; H04L 2209/24

(57) ABSTRACT

A power information transmitting and receiving system in a smart grid comprises: a plurality of home appliances for creating power information by matching consumed power to home appliance identification information; a plurality of smart meters for receiving and storing the power information, creating a first hash value (H_{SM}) for verifying integrity of the stored power information, encrypting the power information using a symmetric key, matching the encrypted data to smart meter identification information; a plurality of data collecting units for decrypting the received data, verifies integrity of the data, collecting the data, creating an integrity verification value for each smart meter, encrypting the smart meter identification information, a total power consumption, a collection time and a third hash value (H_{DCU}), matching the encrypted data to data collecting unit identification information; and an AMI head-end for decrypting the data, performing integrity verification, collecting data for each data collecting unit.

### CROSS REFERENCE TO RELATED APPLICATION

The present application claims the benefit of Korean Patent Application No. 10-2014-0184542 filed in the Korean Intellectual Property Office on Dec. 19, 2014, the entire contents of which are incorporated herein by reference.

### BACKGROUND OF THE INVENTION

1. Field of the Invention

The present invention relates to a power information transmitting and receiving system in a smart grid, and particularly, to a power information transmitting and receiving system in a smart grid, in which when a smart meter matches power consumption of each home appliance to identification information and transmits the power consumption to a data collecting unit, integrity verification is accomplished using a hash value after encryption and decryption is performed using a symmetric key distributed between the smart meter and the data collecting unit and between the data collecting unit and an AMI head-end in advance.

2. Background of the Related Art

A smart grid means an ‘smart power grid’, referring to a next-generation power grid which allows a power supplier and a consumer to bi-directionally exchange real-time information and optimizes energy efficiency by combining information technology (IT) with an existing power grid. As the information technology is advanced, bidirectional communication can be combined even in the energy sector, and it attracts much interest in that distribution of new and renewable power of irregular output such as solar or wind power can be expanded.

The most outstanding advantage of the smart grid (smart power grid) is that it can use energy efficiently. For example, a washing machine at home operates at a time slot of the cheapest electricity rate, and an electric vehicle recharges electricity at a cheap price of midnight rate although it parks in the daytime. In addition, since electricity use behaviors, electricity rates and the like can be observed through a consumer power management device, it is also helpful for voluntary energy saving of consumers.

The ultimate object of the smart grid is reducing overall consumption of energy or inducing efficient use of energy by increasing electricity rates in real-time, at peak time when power consumption increases, or estimating demands on power based on power consumption records of the past and applying different electricity rates in different time slots. To this end, collection of information on power consumption (metering data) in each time slot should be performed accurately.

The components constituting a smart grid are described below.

An Advanced Metering Infrastructure (AMI) is a bidirectional remote metering system for exchanging power consumption information and Demand Response (DR) information (information on demand response of power information) between a smart meter, a Data Collecting Unit (DCU) and a server in a smart grid, and this is used as a concept almost equivalent to the smart grid. In the AMI, power consumption information is periodically transmitted from the smart meter to the server at predetermined short time intervals (e.g., every ten to fifteen minutes) to differentiate electricity rates according to real-time overall power consumption.

The smart meter is a power meter installed at home, which collects and transmits power consumption information at home to the DCU. A Trusted Platform Module (TPM) for storing a safe key and performing an encryption algorithm is installed in the smart meter. The DCU is installed in a small area or an apartment complex, and two to three hundreds smart meters are connected to one DCU and collect power consumption information from the smart meters and transmit the power consumption information to a Meter Data Management System (MDMS, generally referred to as a ‘server’). The server receives the collected power consumption information (metering information) from the DCU and uses the metering information to issue a bill for every user or to settle the bill in real-time and estimate future demands on power consumption.

Meanwhile, since the power consumption information transmitted from the smart meter to the server shows a daily power use pattern of a power consumer, it is worried that privacy of the power consumer, such as a time of using a washing machine which consumes a large amount of power or a time of staying out of home, can be exposed. Although exposure of privacy to outside can be prevent by encrypting the power consumption information in a communication section of the AMI, the risk of privacy exposure still exists from the aspect of the server which collects the information. Furthermore, since billing should be based on consumed power, the power consumption information should not deny the consumed power, and the consumed power should not be changed or manipulated before the power consumption information is transmitted.

### SUMMARY OF THE INVENTION

Therefore, the present invention has been made in view of the above problems, and it is an object of the present invention to provide a power information transmitting and receiving system in a smart grid, in which when a smart meter matches power consumption of each home appliance to identification information and transmits the power consumption to a data collecting unit, integrity verification is accomplished using a hash value after encryption and decryption is performed using a symmetric key distributed between the smart meter and the data collecting unit and between the data collecting unit and an AMI head-end in advance.

To accomplish the above object, according to one aspect of the present invention, there is provided a power information transmitting and receiving system in a smart grid, the system including: a plurality of home appliances for creating power information by matching consumed power to home appliance identification information; a plurality of smart meters for receiving and storing the power information transmitted from the plurality of home appliances, creating a first hash value for verifying integrity of the stored power information, encrypting the power information using a symmetric key, matching the encrypted data to smart meter identification information, and transmits the encrypted data; a plurality of data collecting units for decrypting the received data using the symmetric key, verifies integrity of the data, collecting the data for each smart meter, creating an integrity verification value of the data collected for each smart meter, encrypting the smart meter identification information, a total power consumption, a collection time and a third hash value, matching the encrypted data to data collecting unit identification information, and transmits the encrypted data; and an AMI head-end for decrypting the data received from the data collecting unit, performing integrity verification, collecting data for each data collecting unit, and creating and transmitting billing request information to each smart meter.

As an embodiment related to the present invention, when the smart meter receives and stores the power information transmitted from the plurality of home appliances, the smart meter may store a collection time together.

As an embodiment related to the present invention, the first hash value of the smart meter may be created by concatenating the home appliance identification information, the consumed power, a collection time and the smart meter identification information.

As an embodiment related to the present invention, when the smart meter encrypts the home appliance identification information, the consumed power, a collection time and the firth hash value, the smart meter may encrypt the information using a first symmetric key distributed between the data collecting unit and the smart meter in advance.

As an embodiment related to the present invention, the data collecting unit may decrypt the received data using a first symmetric key and create the second hash value by concatenating the decrypted data and the smart meter identification information.

As an embodiment related to the present invention, the data collecting unit may compare the decrypted first hash value and a newly created second hash value and verify integrity based on a result of the comparison.

As an embodiment related to the present invention, the data collecting unit may create a third hash value by concatenating the smart meter identification information, the total power consumption (TEU), the collection time and the data collecting unit identification information (DCU-ID).

As an embodiment related to the present invention, the AMI head-end may create a fourth hash value by concatenating the decrypted data, the data and the data collecting unit identification information.

As an embodiment related to the present invention, the AMI head-end may compare the decrypted third hash value and the newly created fourth hash value and verify integrity based on a result of the comparison.

As an embodiment related to the present invention, when the AMI head-end confirms individual data of each of the plurality of home appliances, the AMI head-end may extract the individual data from the data of the home appliances stored in a data collecting unit and confirm the individual data.

### BRIEF DESCRIPTION OF THE DRAWINGS

FIG. 1 is a view showing a power information transmitting and receiving system in a smart grid according to the present invention.

FIG. 2 is a view showing a power information processing method of a power information transmitting and receiving system in a smart grid according to the present invention.

### DESCRIPTION OF SYMBOLS

100: Home appliance
200: Smart meter
300: Data collecting unit
400: AMI head-end
500: Billing system

### DETAILED DESCRIPTION OF THE PREFERRED EMBODIMENT

It is noted that Technical terms used in the specification are used to just describe a specific embodiment and do not intend to limit the present invention. Further, if the technical terms used in the specification are not particularly defined as other meanings in the specification, the technical terms should be appreciated as meanings generally appreciated by those skilled in the art and should not be appreciated as excessively comprehensive meanings or excessively reduced meanings. Further, when the technical term used in the specification is a wrong technical term that cannot accurately express the spirit of the present invention, the technical term is substituted by a technical term which can correctly appreciated by those skilled in the art to be appreciated. In addition, a general term used in the present invention should be analyzed as defined in a dictionary or according to front and back contexts and should not be analyzed as an excessively reduced meaning.

Moreover, if singular expression used in the specification is not apparently different on a context, the singular expression includes a plural expression. Further, in the present invention, it should not analyzed that a term such as “comprising” or “including” particularly includes various components or various steps disclosed in the specification and some component or some steps among them may not be included or additional components or steps may be further included.

Hereinafter, embodiments of the present invention will be described in detail with reference to the accompanying drawings, in which like or similar reference numerals refer to like elements regardless of reference numerals, and a duplicated description thereof will be omitted.

In addition, in describing the present invention, when it is determined that the detailed description of the known art related to the present invention may obscure the gist of the present invention, the detailed description thereof will be omitted.

Further, it is noted that the accompanying drawings are used just for easily appreciating the spirit of the present invention and it should not be analyzed that the spirit of the present invention is limited by the accompanying drawings.

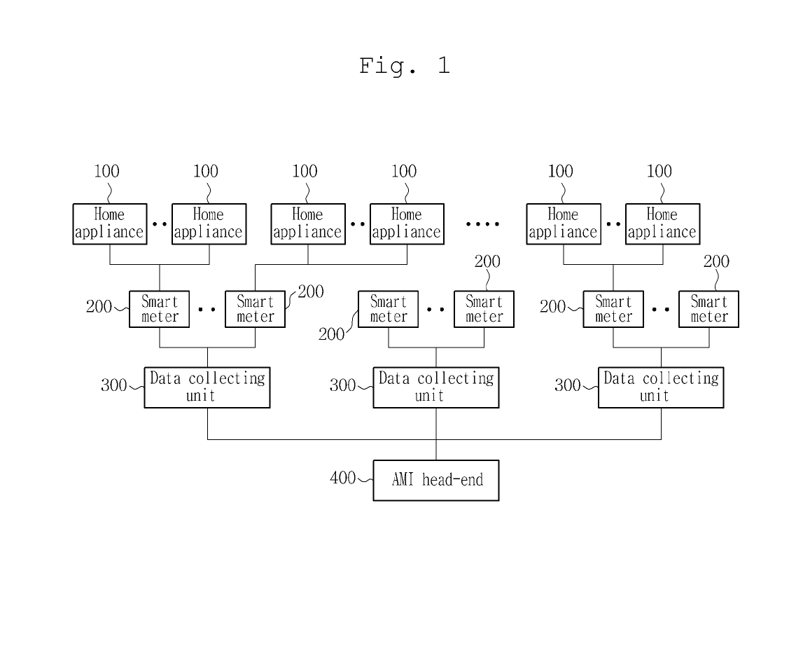

FIG. 1 is a view showing a power information transmitting and receiving system in a smart grid according to the present invention.

As shown in FIG. 1, a power information transmitting and receiving system in a smart grid according to the present invention is configured of a plurality of home appliances 100, a plurality of smart meters 200, a plurality of data collecting units 300 and an AMI head-end 400.

The plurality of home appliances 100 creates power information by matching home appliance identification information and transmits the power information to the smart meter 200.

The plurality of smart meters 200 receives and stores the power information transmitted from the plurality of home appliances 100, creates a first hash value (H_{SM}) for verifying integrity of the stored power information, encrypts the power information using the hash value, matches the encrypted data to smart meter identification information, and transmits the encrypted data.

When the smart meter 200 receives and stores the power information transmitted from the plurality of home appliances 100, the smart meter stores a collection time together.

The first hash value (H_{SM}) of the smart meter 200 is created by concatenating the home appliance identification information, consumed power, the collection time and the smart meter identification information.

When the smart meter 200 encrypts the home appliance identification information, the consumed power, the collection time and the hash value (H_{SM}), the smart meter encrypts the information using a first symmetric key distributed between the data collecting unit and the smart meter in advance.

The plurality of data collecting units 300 decrypts the received data using the symmetric key and verifies integrity of the data, collects data for each smart meter and creates an integrity verification value of the data collected for each smart meter, encrypts the smart meter identification information, total power consumption, the collection time and a second hash value (H′_{SM}), matches the encrypted data to data collecting unit identification information, and transmits the encrypted data.

The data collecting unit 300 decrypts the received data using the first symmetric key and creates the second hash value (H′_{SM}) by concatenating the decrypted data and the smart meter identification information.

The data collecting unit 300 compares the decrypted first hash value (H_{SM}) and the newly created second hash value (H′_{SM}) and verifies integrity based on a result of the comparison.

The data collecting unit 300 creates a third hash value (H_{DCU}) by concatenating the smart meter identification information, total power consumption, a collection time and data collecting unit identification information (DCU-ID).

The AMI head-end 400 decrypts the data received from the data collecting unit 300, performs integrity verification, collects data for each data collecting unit, and creates and transmits billing request information to each smart meter.

The AMI head-end 400 creates a fourth hash value (H′_{E}) by concatenating the decrypted data, the data and the data collecting unit identification information, compares the decrypted third hash value (H_{DCU}) and the newly created fourth hash value (H′_{DCU}), and verifies integrity based on a result of the comparison.

When the AMI head-end 400 confirms individual data of each of the plurality of home appliances, the AMI head-end 400 extracts the individual data from the data of the home appliances stored in a data collecting unit and confirms the individual data.

A power information processing method of a power information transmitting and receiving system in a smart grid configured as described above is described below.

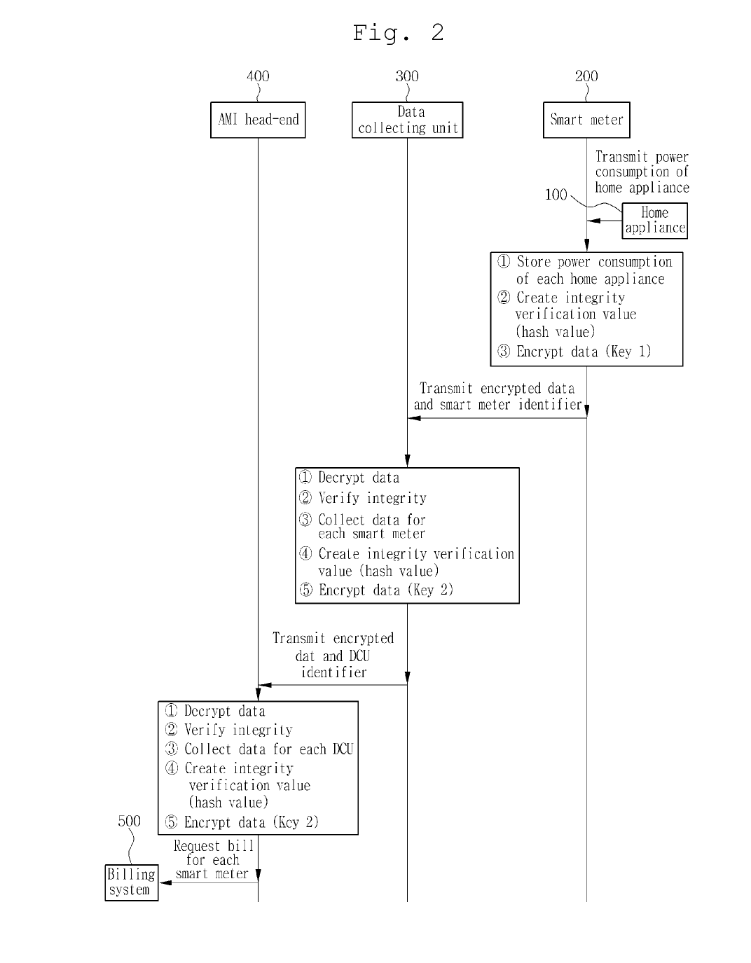

FIG. 2 is a view showing a power information processing method of a power information transmitting and receiving system in a smart grid according to the present invention.

As shown in FIG. 2, first, the home appliances 100 create power information by matching consumed power to home appliance identification information and transmits the power information to the smart meters (n smart meters). Here, the home appliance identification information is configured of a product number, an ID and the like.

Then, the smart meter 200 stores the identification information (HA-ID), the consumed power and the collection time (CT) of each home appliance 100 included in the power information received from the home appliance 100.

The power information of the home appliance 100 stored in the smart meter 200 is information provided to confirm power consumption of each home appliance in real-time, and, generally, in a smart grid environment, a smart meter transmits consumed power collected every fifteen minutes.

In addition, the smart meter 200 creates a first hash value (H_{SM}) for verifying integrity of the stored data. The smart meter 200 creates the first hash value (H_{SM}) by concatenating the home appliance identification information, consumed power, a collection time and smart meter identification information (SM-ID). At this point, the smart meter identification information is also included to verify that the information is transmitted from a corresponding smart meter 200.

The smart meter 200 encrypts the home appliance identification information, the consumed power, the collection time and the firth hash value (H_{SM}). That is, the smart meter 200 encrypts the data using a first symmetric key (Key 1) distributed between the data collecting unit 300 and the smart meter 200 in advance, and, at this point, the first symmetric key (Key 1) and a second symmetric key (Key 2) described below are distributed in advance using a public key algorithm.

Then, the smart meter 200 transmits the encrypted data and the smart meter identification information to the data collecting unit 300.

Then, the data collecting unit 300 decrypts the received data through the first symmetric key (Key 1), creates a second hash value (H′_{SM}) by concatenating the decrypted data (the home appliance identification information, the consumed power, the collection time and the like) and the smart meter identification information, and verifies integrity by comparing the decrypted first hash value (H_{SM}) and the newly created hash value (H′_{SM}).

The data collecting unit 300 collects data for each smart meter 200. That is, the data collecting unit 300 collects data for each smart meter 200 using the smart meter identification information as an index and creates an integrity verification value of the data collected for each smart meter 200.

The data collecting unit 300 creates a third hash value (H_{DCU}) by concatenating the smart meter identification information, total power consumption, a collection time (including a period) and data collecting unit identification information (DCU-ID).

The data collecting unit 300 encrypts the smart meter identification information, the total power consumption, the collection time (including a period) and the third hash value (H_{DCU}). At this point, the data collecting unit 300 encrypts the data using a second symmetric key (Key 2) distributed between the AMI head-end 400 and the data collecting unit 300 in advance. At this point, the first and second symmetric keys (Key 1 and Key 2) used in the protocol are distributed in advance using a public key algorithm.

Finally, the data collecting unit 300 transmits the encrypted data and the data collecting unit identification information.

The AMI head-end 400 decrypts the data received from the data collecting unit 300 through the second symmetric key (Key 2), and creates a fourth hash value (H′_{DCU}) by concatenating the decrypted data (the smart meter identification information, the total power consumption, the collection time, the third hash value and the like) and the data collecting unit identification information.

The AMI head-end 400 compares the decrypted third hash value (H_{DCU}) and the newly created fourth hash value (H′_{DCU}), verifies integrity based on a result of the comparison, and acquires and stores data for each data collecting unit 300 using the data collecting unit identification information as an index. Therefore, when the data needs to be individually confirmed for each home appliance 100 later, corresponding data is searched and provided from the data stored in the data collecting unit 300. In this manner, data search time can be reduced.

Finally, the AMI head-end 400 transmits the smart meter identification information and the total power consumption to the billing system 500 so that billing is requested for the user.

The present invention is effective in that when a smart meter matches power consumption of each home appliance to home appliance identification information and transmits the power consumption to a data collecting unit, integrity verification is accomplished using a hash value after encryption and decryption is performed using a symmetric key distributed between the smart meter and the data collecting unit and between the data collecting unit and an AMI head-end in advance.

The present invention described above can be changed and modified by those skilled in the art without departing from the inherent characteristics of the present invention. While the present invention has been described with reference to the particular illustrative embodiments, it is not to be restricted by the embodiments but only by the appended claims. It is to be appreciated that those skilled in the art can change or modify the embodiments without departing from the scope and spirit of the present invention. The embodiments disclosed in the present invention are provided not to limit the technical concept of the present invention but to illustrate the technical concept of the present invention. Therefore, the scope of the technical concept of the present invention is not limited by such embodiments. The scope of the protection of the present invention should be determined by reasonable interpretation of the appended claims and all technical concepts coming within the equivalency range of the present invention should be interpreted to be embraced in the scope of the right of the present invention.

What is claimed is:

1. A power information transmitting and receiving system in a smart grid, the system comprising:
a plurality of home appliances for creating power information by matching consumed power to home appliance identification information;
a plurality of smart meters for receiving and storing the power information transmitted from the plurality of home appliances, creating a first hash value (H_{SM}) for verifying integrity of the stored power information, encrypting the power information using a symmetric key, matching the encrypted data to smart meter identification information, and transmits the encrypted data;
a plurality of data collecting units for decrypting the received data using the symmetric key, verifies integrity of the data, collecting the data for each smart meter, creating an integrity verification value of the data collected for each smart meter, encrypting the smart meter identification information, a total power consumption, a collection time and a third hash value (H_{DCU}), matching the encrypted data to data collecting unit identification information, and transmits the encrypted data; and
an AMI head-end for decrypting the data received from the data collecting unit, performing integrity verification, collecting data for each data collecting unit, and creating and transmitting billing request information to each smart meter.

2. The system according to claim 1, wherein when the smart meter receives and stores the power information transmitted from the plurality of home appliances, the smart meter stores a collection time together.

3. The system according to claim 1, wherein the first hash value (H_{SM}) of the smart meter is created by concatenating the home appliance identification information, the consumed power, a collection time and the smart meter identification information.

4. The system according to claim 1, wherein when the smart meter encrypts the home appliance identification information, the consumed power, a collection time and the firth hash value (H_{SM}), the smart meter encrypts the information using a first symmetric key distributed between the data collecting unit and the smart meter in advance.

5. The system according to claim 1, wherein the data collecting unit decrypts the received data using a first symmetric key and creates the second hash value (H′_{SM}) by concatenating the decrypted data and the smart meter identification information.

6. The system according to claim 1, wherein the data collecting unit compares the decrypted first hash value (H_{SM}) and a newly created second hash value (H′_{SM}) and verifies integrity based on a result of the comparison.

7. The system according to claim 1, wherein the data collecting unit creates a third hash value (H_{DCU}) by concatenating the smart meter identification information, the total power consumption (TEU), the collection time and the data collecting unit identification information (DCU-ID).

8. The system according to claim 1, wherein the AMI head-end creates a fourth hash value (H′_{DCU}) by concatenating the decrypted data, the data and the data collecting unit identification information.

9. The system according to claim 8, wherein the AMI head-end compares the decrypted third hash value (H_{DCU}) and the newly created fourth hash value (H′_{DCU}) and verifies integrity based on a result of the comparison.

10. The system according to claim 1, wherein when the AMI head-end confirms individual data of each of the plurality of home appliances, the AMI head-end extracts the individual data from the data of the home appliances stored in the data collecting unit and confirms the individual data.
